(19) United States
(12) Patent Application Publication
(10) Pub. No.: US 2013/0187026 A1
(43) Pub. Date: Jul. 25, 2013

(54) Monitoring Device of a Machine Tool

(71) Applicants: Sebastian Jackisch, Ludwigsburg (DE); Tobias Seemann, Otigheim (DE)

(72) Inventors: Sebastian Jackisch, Ludwigsburg (DE); Tobias Seemann, Otigheim (DE)

(73) Assignee: Robert Bosch GmbH, Stuttgart (DE)

(21) Appl. No.: 13/511,975

(22) PCT Filed: Oct. 14, 2010
(86) PCT No.: PCT/EP2010/065381

§ 371 Date: Oct. 2, 2012

(30) Foreign Application Priority Data
Dec. 10, 2009 (DE) 10 2009 054 491.7

(51) Int. Cl. F16P 3/14

(52) U.S. Cl. CPC F16P 3/147
USPC 250/200

(57) ABSTRACT

A monitoring device of a machine tool is provided. The monitoring device includes a detection device that is configured to detect the presence of a type of material in a machine tool region. The monitoring device also includes a hand marking unit, which has a marking element. The marking element is specifically adjusted to be detected by the detection device to enable marking a hand of an operator.

### PRIOR ART

The invention proceeds from a monitoring device of a machine tool as claimed in the preamble of claim 1.

DE 10 2008 003 606 A1 discloses a monitoring device of a machine tool having an identification unit for identifying the presence of a type of material in a machine tool working area, with the presence identification operation being based on a spectral evaluation of radiation, and sensitivity ranges for detecting the radiation being arranged in a plurality of different wavelength ranges of the electromagnetic spectrum.

### DISCLOSURE OF THE INVENTION

The invention proceeds from a monitoring device of a machine tool having an identification device which is provided for identifying the presence of a type of material in a machine tool working area.

In this context, a “machine tool working area” is intended to mean, in particular, an area of a machine tool in the immediate vicinity of a tool. An area in the “immediate” vicinity of the tool is intended to mean, in particular, an area in which each point in the area is at a very short distance from the tool, said distance being a maximum of 10 cm, preferably a maximum of 5 cm, and particularly preferably a maximum of 2 cm.

It is proposed that the monitoring device comprises at least one hand marking unit, which has at least one marking element which is specially adapted for identification by the identification device, for marking a hand of an operator. In this context, “specially adapted” is intended to mean, in particular, that the marking element of the hand marking unit has a specially selected and/or adjusted feature which occurs or can be found in the vicinity of the machine tool only with a negligibly low probability and to which the identification device reacts in a specific way. As a result, a hand of an operator can also advantageously be identified without areas of skin being visible.

By way of example, the hand marking unit can be a glove which has a specific, uniformly distributed color on its outside. The identification device could then comprise a camera, the lens of said camera being equipped with an interference filter and the transmission maximum of said interference filter being within an electromagnetic radiation which is reflected by the color of the glove in daylight, so that, in a suitable refinement, the operator can use gloves for protection against the cold and/or rough surfaces of a workpiece and, at the same time, operator safety is provided by the monitoring device. In addition, detection of the hand of the operator of the machine tool when entering the machine tool working area is possible even when the operator is wearing gloves for protection against cold or mechanical injury and the skin of the hand of the operator is covered to the outside, so that operator safety can be ensured even in an operating situation of this kind.

In a further refinement, the identification device could comprise an RFID (Radio Frequency Identification) reader in the UHF radio band and the glove could have a passive transponder for absorbing the UHF radio waves emitted by the reader and the frequencies of the reader and the frequency of the passive transponder could be matched to one another.

The at least one marking element and the identification device are particularly advantageously specially matched to one another in respect of optical interaction. In this context, “optical interaction” is intended to mean, in particular, every mutually influencing effect of electromagnetic radiation in an optical wavelength range of the electromagnetic spectrum and material objects and, in particular, directed reflection and non-directed (diffuse) reflection or partial reflection, transmission and absorption with and without subsequent emission of electromagnetic radiation. In this context, an “optical wavelength range” is understood to mean, in particular, the wavelength range of visible light (VIS), the wavelength range of UV light and the wavelength range of near infrared radiation (NIR). In this context, the “range of visible light” (VIS) is intended to mean, in particular, light from a portion of the electromagnetic spectrum with wavelengths of between 380 nm and 780 nm. In this context, a “range of near infrared radiation” (NIR) is intended to mean, in particular, light from a portion of the electromagnetic spectrum with wavelengths of between 780 nm and 3.0 μm (IR-A, IR-B). In this context, “UV light” is intended to mean, in particular, light from the portion of the electromagnetic spectrum with wavelengths of between 1 nm and 380 nm and, in particular, of between 200 nm and 380 nm (UV-A).

A monitoring device of this kind, when suitably designed, can react particularly quickly and have a low false alarm rate. In addition, it can be adapted in a simple manner by adjusting light sources, optical filters and optical sensors.

It is also proposed that the identification device is provided for identifying the presence of the at least one hand marking unit in a machine tool working area by means of the spectral evaluation of electromagnetic radiation and has at least one first detector element which is provided for detecting the electromagnetic radiation for the purpose of presence identification. As a result, in a suitable refinement, particularly reliable identification with a particularly low false alarm rate can be achieved by restriction to a range of the electromagnetic spectrum.

It is also proposed that the at least one detector element has a sensitivity range for electromagnetic radiation which extends from the UV range to the NIR range. The detector element can be used to identify the presence of the marking element in a simple manner on the basis of different interactions with the electromagnetic radiation of the UV range. In this context, a “sensitivity range of the detector element” is intended to mean, in particular, a wavelength range of electromagnetic radiation which comprises the wavelengths of that radiation which generate a signal amplitude in the detector element, which signal amplitude is at least a percentage of a signal amplitude which generates electromagnetic radiation with a wavelength in the detector element to which the detector element has a maximum sensitivity.

It is also proposed that the identification device has an emission unit having at least one range of emission for electromagnetic radiation, which range is arranged at least partially in a UV range of the electromagnetic spectrum, and the at least one hand marking unit is, for the purpose of presence identification, intended to interact in a targeted manner with the electromagnetic radiation of the UV range in at least one operating mode. A high signal-to-noise ratio of a detector signal can be achieved and false alarms can be effectively suppressed by virtue of the use of additional electromagnetic radiation in the UV range.

The at least one hand marking unit having an identification device according to DE 10 2008 003 606 A1 on an existing machine tool for presence identification can advantageously interact in a targeted manner with radiation in the UV range, this radiation being emitted by an emission unit of the identification device. After adjusting a signal evaluation means of the identification device, the existing monitoring device of the machine tool can be changed, with little additional expenditure, to an improved technical state which, in addition to identifying the areas of skin of the operator, also permits the use of gloves for protecting against cold or mechanical injury while at the same time ensuring operator safety.

It is also proposed that the at least one hand marking unit for marking a hand of an operator of the machine tool for presence identification has an albedo of more than 0.10 in at least one portion of the UV range of the electromagnetic spectrum. In this context, an “albedo” is intended to mean, in particular, a ratio of a diffusely reflected light intensity to an incident light intensity. Measures for increasing the albedo of an object are familiar to a person skilled in the art. In a suitable refinement, a signal amplitude of the detector element can increase when the hand marking unit enters the machine tool working area, as a result of which presence identification can be achieved in a simple and reliable manner.

When the at least one marking element for marking the hand of the operator of the machine tool for presence identification has a degree of reflection of electromagnetic radiation in at least one portion of the UV range of the electromagnetic spectrum which is greater than a degree of absorption in the portion of the UV range of the electromagnetic spectrum, the presence of the hand of the operator in the machine tool working area can be detected in a particularly simple manner.

In addition, it is proposed that the at least one marking element for marking the hand of the operator for presence identification has at least one photoluminescence property. In this context, a “photoluminescence property” is intended to mean, in particular, that the marking element, by interacting with the electromagnetic radiation of the UV range which is emitted by the emission unit, is excited to subsequently emit electromagnetic radiation with a different, generally longer, wavelength. In particular, the photoluminescence property can comprise a fluorescence property or a phosphorescence property. The marking element preferably has fluorescence properties.

In a suitable refinement, the signal amplitude of the detector element can thus increase, when the hand marking unit enters the machine tool working area, due to radiation which is additionally emitted in a range of visible light (visible range, VIS) of the electromagnetic spectrum, as a result of which presence identification can be achieved in a particularly simple and reliable manner.

An advantageously high signal-to-noise ratio of the signal amplitude of the detector element when the hand marking unit enters the machine tool working area can be achieved when the at least one emission unit is provided for emitting amplitude-modulated electromagnetic radiation. In this context, “amplitude-modulated electromagnetic radiation” is intended to mean, in particular, that an intensity of the electromagnetic radiation varies over time and in addition, in particular, that it varies with a chronological periodicity. In a suitable refinement, electromagnetic background radiation which is not correlated with the electromagnetic radiation of the emission unit can advantageously be eliminated by filtering measures which are familiar to a person skilled in the art and are applied to the signal amplitude of the detector element.

In an advantageous refinement, the monitoring device comprises a second detector element which has a sensitivity range for electromagnetic radiation which is different from the sensitivity range of the first detector element. As a result, in a suitable refinement, the signal amplitude of the first detector element can be determined substantially by the electromagnetic radiation which is induced by the electromagnetic radiation of the UV range which is emitted by the emission unit. The signal amplitude of the second detector element can then be determined substantially by the electromagnetic radiation of the UV range of the emission unit which is reflected by the hand marking unit. In this context, “substantially” is intended to mean, in particular, preferably more than 50%, particularly preferably more than 70%. The presence of the hand marking unit in the machine tool working area can be identified in a particularly reliable manner by such division into separate signal components.

In an advantageous embodiment of the invention, it is proposed that the at least one hand marking unit is in the form of a glove, the outer surface of said glove having a photoluminescent dye, this providing a simple and cost-effective solution to the problem of presence identification, in which solution the hand of the operator can be protected by the monitoring device and, at the same time, can be protected against the cold and/or rough surfaces of the workpiece. The dye preferably has fluorescence properties.

It is also proposed that the identification device has an evaluation unit which is provided for identifying the presence of the at least one hand marking unit on the basis of a mathematical relationship between at least two radiation characteristic variables which are associated with different ranges of the electromagnetic spectrum. In this case, preferred ranges of the electromagnetic spectrum are the UV range, in particular the UV-A range, and the range of visible light (VIS). As a result, particularly reliable presence identification with a low number of false alarms can be achieved.

It is further proposed that the evaluation unit is provided for providing a signal, which at least initiates triggering of a protection system of the machine tool, on the basis of the presence of the at least one hand marking unit being identified. As a result, a protective measure can be rapidly implemented after a safety-related operator control situation is identified, and safety of the operator can be improved.

### DRAWING

Further advantages can be gathered from the following description of the drawing. Exemplary embodiments of the invention are illustrated in the drawing. The drawing, the description and the claims contain numerous features in combination. A person skilled in the art will expediently also consider the features individually and combine them to form expedient further combinations.

In the drawing:

FIG. 1 shows a side view of a machine tool, which is in the form of a circular bench saw and has a monitoring device,

FIG. 2 shows a plan view of the circular bench saw according to FIG. 1 with a reaction area of the identification device,

FIG. 3 shows a basic diagram of a view of a detail of the monitoring device of the machine tool according to FIG. 1,

FIG. 4 shows an exemplary embodiment of the monitoring device of the machine tool according to FIG. 1,

FIG. 5 shows a schematic illustration of signal amplitudes of the detector element of the monitoring device according to FIG. 3,

FIG. 6 shows a further exemplary embodiment of a monitoring device,

FIG. 7 shows a schematic illustration of signal amplitudes of the detector element of the monitoring device according to FIG. 5,

FIG. 8 shows a further exemplary embodiment of a monitoring device,

FIG. 9 shows a schematic illustration of sensitivity ranges and signal amplitudes of two detector elements of the monitoring device according to FIG. 7, and

FIG. 10 shows an absorption spectrum and a fluorescence spectrum of the fluorescence dye Rhodamine 6G.

### DESCRIPTION OF THE EXEMPLARY EMBODIMENTS

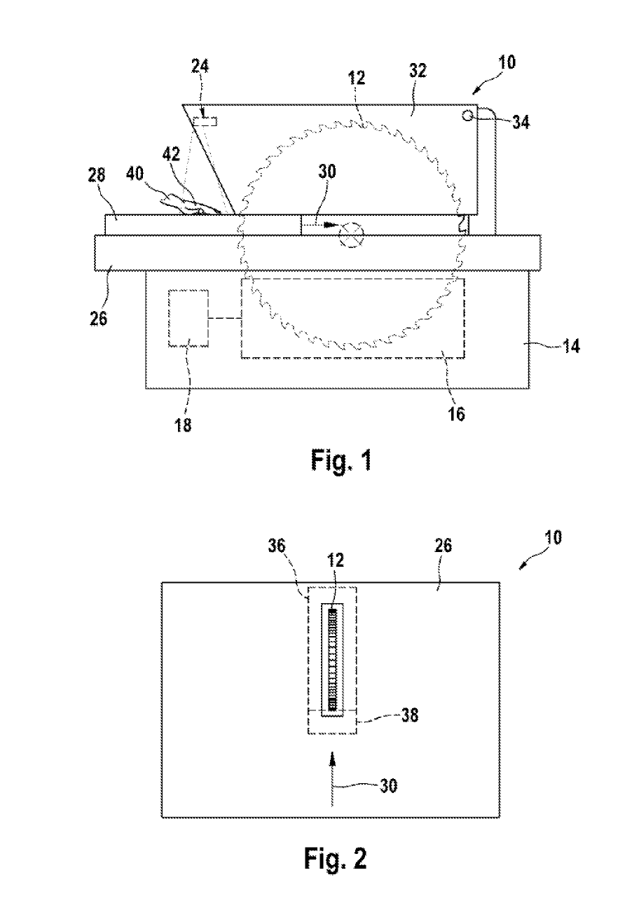

FIG. 1 shows a side view of a machine tool 10 which is in the form of a circular bench saw. The machine tool 10 has a tool 12 which is in the form of a disk-like saw blade and is driven in a rotary manner during sawing operation by means of a drive unit 16 which is arranged in a drive housing 14 and is in the form of an electric motor. A saw bench 26 for supporting a workpiece 28 which is to be processed is supported on the drive housing 14. In order to protect an operator against injury, the machine tool 10 comprises a protective hood 32 in a manner which is known per se, said protective hood completely surrounding that part of the tool 12 which projects out of the saw bench 26 when the machine tool 10 is in the inoperative state. In order to process the workpiece 28, said workpiece is pushed by the user in a working direction 30 which is directed toward the tool 12. In the process, the protective hood 32, which is mounted such that it can rotate about a rotation axis 34, is pivoted upward by the workpiece 28, as a result of which the tool cutting edge is exposed.

In order to increase operator safety, the machine tool 10 is equipped with a monitoring device. The monitoring device has an identification device 24 which is provided for identifying the presence of a type of material in a machine tool working area 36 of the machine tool 10. The machine tool working area 36 is illustrated in a plan view of the machine tool 10 in FIG. 2. The protective hood 32 has not been illustrated for reasons of clarity. The identification device 24 has a reaction area 38 which is associated (FIG. 1) with operation of an actuator unit 18 which is coupled to the drive unit 16 and which is operatively connected to the identification device 24. When the actuator unit 18 is actuated, a protective system of the machine tool is activated in a known manner and the tool 12 is stopped by the drive unit 16, as a result of which any potential injury to the operator by the tool 12 is avoided.

The operator wears gloves to mechanically protect his hand and to protect against cold. The gloves simultaneously form a hand marking unit 40 for marking the hand of the operator in such a way that the presence of one of the gloves marks and implies the simultaneous presence of the hand of the operator. To this end, the hand marking unit 40 which is formed by the glove has a marking element 42 which is specially adapted for identification by the identification device, specifically the marking element 42 and the identification device 24 are matched to one another in respect of optical interaction, as will be discussed below.

In the illustrated exemplary embodiment, the identification device 24 is arranged in the protective hood 32, specifically in a front region of the protective hood 32 which is arranged in front of the tool 12 in the working direction 30. The identification device 24 can, in principle, also be arranged on a splitting wedge, on a parallel stop and/or on an extension arm above the saw bench.

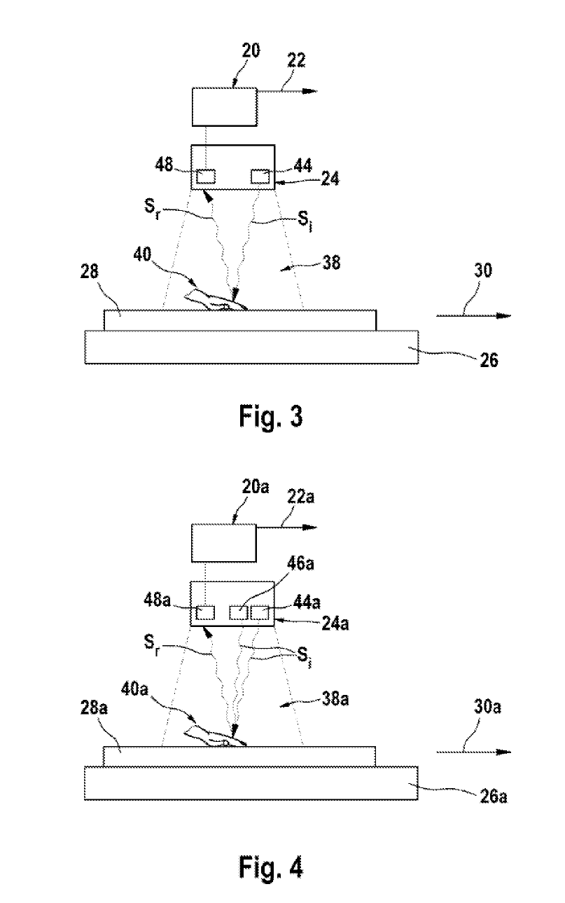

FIG. 3 shows a side view of the monitoring device having the identification device 24 in a schematic illustration of a detail of the machine tool 10. The identification device 24 comprises an emission unit 44 having an area for emitting electromagnetic radiation Sᵢ which is arranged in the UV-A range of the electromagnetic spectrum with wavelengths of between 315 nm and 380 nm. The emission unit 44 is provided for emitting electromagnetic radiation Sᵢ, which is amplitude-modulated at a modulation frequency f_{mod1} of 15 kHz, in the UV-A range with an amplitude maximum at a wavelength of 375 nm. The hand marking unit 40 is, for the purpose of presence identification, provided for interacting in a targeted manner with the electromagnetic radiation Sᵢ of the UV-A range in at least one operating mode. The electromagnetic radiation Sᵢ, which is emitted by the emission unit 44, in the UV range is directed at the reaction area 38 which corresponds to a subarea of the machine tool working area 36 and is arranged in front of the tool 12 in the working direction 30 (FIG. 2).

The identification device 24 is provided for identifying the presence of the hand marking unit 40 in the reaction area 38 by means of the spectral evaluation of electromagnetic radiation Sᵣ and, to this end, comprises a detector element 48 which is formed by an InGaAs detector and is provided, for the purpose of presence identification, for detecting the electromagnetic radiation Sᵣ. The electromagnetic radiation Sᵣ of the UV-A range, which is reflected by materials in the reaction area 38 of the identification device 24 in a directed manner or diffusely in the direction of the detector element 48, generates an electrical signal in the detector element 48, said electrical signal being supplied to an input of an evaluation unit 20 of the identification device 24. The signal which is generated in the detector element 48 is substantially proportional to an intensity I of the radiation Sᵣ which is integrated over the entire sensitivity range.

The evaluation unit 20 of the identification device 24 is also provided for providing a signal 22, which at least initiates triggering of the actuator unit 18, which is coupled to the drive unit 16, of the machine tool 10 (FIG. 1), on the basis of the presence of the at least one hand marking unit 40 being identified.

FIGS. 4, 6 and 8 show alternative exemplary embodiments of monitoring devices which are intended to be used with the above-described machine tool 10 and the components which are common to all the exemplary embodiments. Components, features and functions which remain substantially identical are, in principle, denoted using the same reference symbols. However, in order to draw a distinction between the exemplary embodiments, the letters a, b and c are added to the reference symbols of the exemplary embodiments, it being possible to make reference to the description of the exemplary embodiment in FIGS. 1, 2 and 3 in respect of the components, features and functions which remain the same.

The exemplary embodiment of the monitoring device shown in FIG. 4 has, in addition to the emission unit 44a, a second emission unit 46a. The second emission unit 46a is provided for emitting electromagnetic radiation Sᵢ, which is amplitude-modulated at a modulation frequency f_{mod2} of 35 kHz, in the wavelength range of visible light (VIS), with an amplitude maximum at a wavelength λ of 740 nm. The detector element 48a has a sensitivity range for electromagnetic radiation which extends from the UV range to a near infrared range. The hand marking unit 40a which is formed by the glove is composed of a material which has a comparatively high albedo of 0.12 for electromagnetic radiation of the UV range and a degree of absorption of 0.95 for electromagnetic radiation with a wavelength λ of 740 nm.

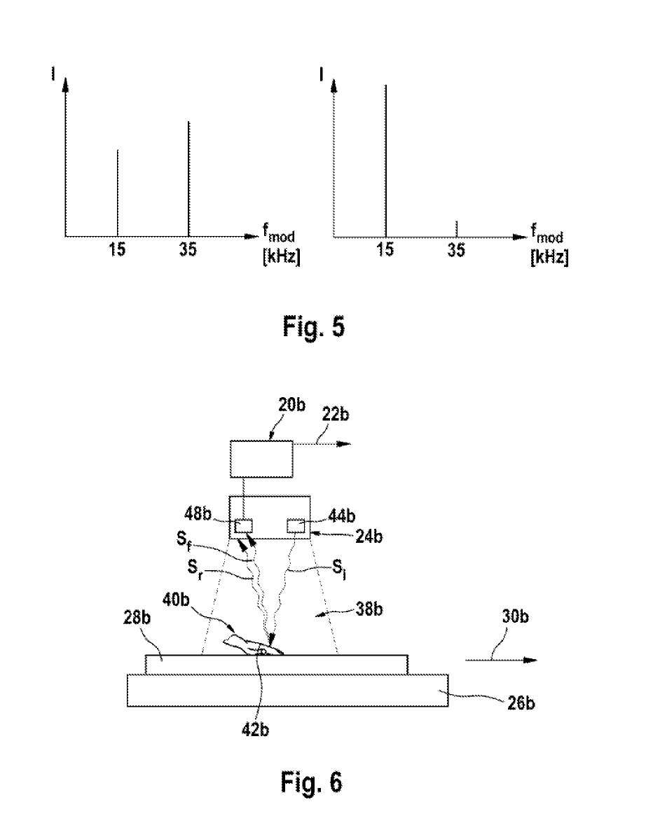

FIG. 5 shows the signal amplitudes of the detector element 48a which are filtered in a known manner with electronic bandpasses at the respective modulation frequencies f_{mod1}, f_{mod2} of the two emission units 44a, 46a. Each amplitude is proportional to an intensity I of the electromagnetic radiation Sᵢ which is emitted with the defined modulation frequency f_{mod1}, f_{mod2}. In the situation described by the diagram on the left-hand side in FIG. 5, the hand marking unit 40a is located outside the reaction area 38a. The diagram on the right-hand side of FIG. 5 shows, qualitatively, a change in the amplitudes due to the hand marking unit 40a entering the reaction area 38a. The evaluation unit 20a is provided for identifying the presence of the hand marking unit 40a on the basis of a mathematical relationship between two radiation characteristic variables, specifically of intensities I, which are formed by the two amplitudes and are associated with different ranges of the electromagnetic spectrum, specifically the UV range and the VIS range. The evaluation unit 20a is further provided for comparing the mathematical relationship between the two radiation characteristic variables with threshold values which are stored in a memory element in an access area of the evaluation unit 20a, and for providing a signal 22a, which at least initiates triggering of the actuator unit 18, which is coupled to the drive unit 16, of the machine tool 10, when the threshold value is exceeded for the purpose of displaying the presence identification situation.

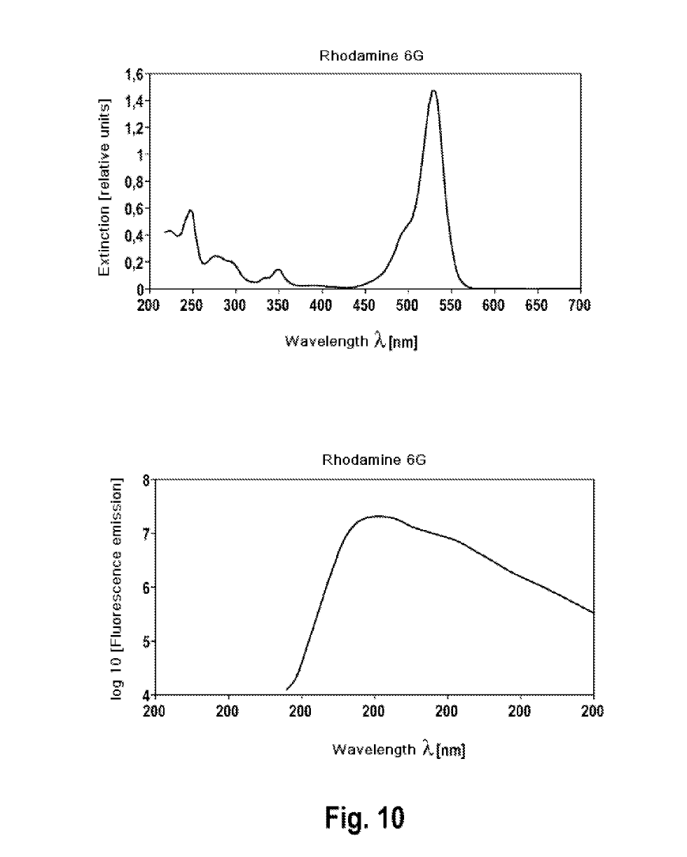

A further exemplary embodiment of a monitoring device is shown in FIG. 6. An identification device 24b comprises an emission unit 44b which is designed to be physically identical to the emission unit 44 according to FIG. 3 and likewise is provided for emitting electromagnetic radiation Sᵢ, which is amplitude-modulated at a modulation frequency f_{mod1} of 15 kHz, in the UV-A range, with an amplitude maximum at a wavelength λ of 375 nm. A detector element 48b has a sensitivity range for electromagnetic radiation which extends from the UV range to a near infrared range (NIR). A hand marking unit 40b which is formed by the glove has a marking element 42b for marking the hand of the operator for presence identification, which marking element has a photoluminescence property. The glove is composed of a material of which the outer surface comprises the fluorescence dye Rhodamine G which forms a marking element 42b which is excited by the electromagnetic radiation Sᵢ from the UV range for spontaneous emission of electromagnetic radiation S_{f} in the range of visible light (VIS) (FIG. 10). Visible light is emitted after a very short time after excitation in comparison to a period length of the modulation frequency f_{mod1}, so that the emission of visible light can be considered to not be shifted in respect of time for practical considerations and a modulation frequency of visible light corresponds to the modulation frequency f_{mod1} of the exciting UV light, substantially without broadening a frequency profile.

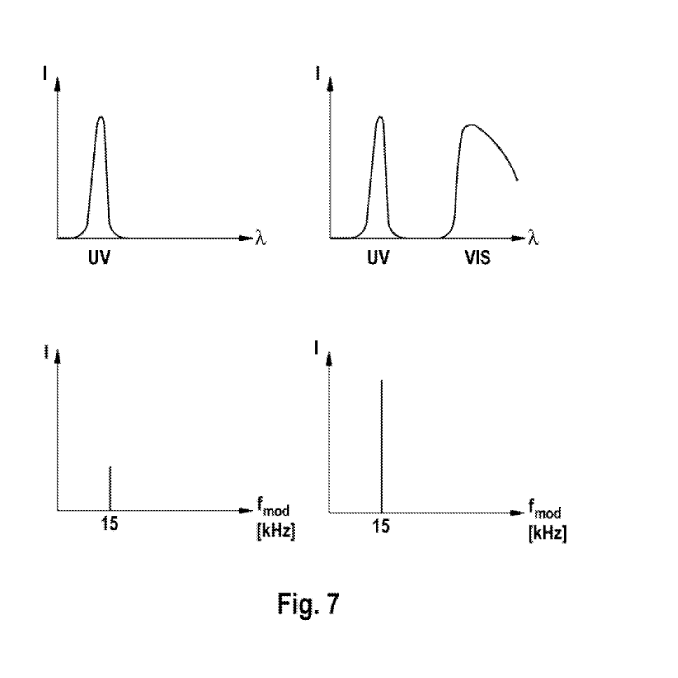

FIG. 7 shows signal diagrams which each qualitatively describe a situation in which the hand marking unit 40b which is formed by the glove is located outside (diagrams on the left-hand side) or inside (diagrams on the right-hand side) the reaction area 38b. The two upper diagrams show an intensity I of the radiation Sᵣ, S_{f} as a function of a wavelength λ of the electromagnetic radiation Sᵣ, S_{f}. While only the radiation Sᵢ which is emitted at the modulation frequency f_{mod1} and radiation Sᵣ of the UV range which is directly or diffusely reflected into the detector element 48b are detected by said detector element when the glove is not present, the diagram on the right-hand side shows electromagnetic radiation S_{f} in the range of visible light (VIS) which, with the glove in the reaction area 38b, is emitted by said glove at the modulation frequency f_{mod1} on account of the fluorescence properties of the dye.

The signal amplitude which is generated in the detector element 48b and filtered in a known manner with an electronic bandpass is proportional to an intensity I of the radiation Sᵣ, S_{f} which is integrated over the entire sensitivity range. The fluorescence dye Rhodamine G has a degree of partial reflectance which can reach values of more than 200% in the event of excitation with the electromagnetic radiation Sᵢ of the UV range, so that the signal amplitude rises when the glove enters the reaction area 38b. The evaluation unit 20b is provided for comparing the signal amplitude of the detector element 48b with a threshold value which is stored in a memory element in an access area of the evaluation unit 20b, and for providing a signal 22b, which at least initiates triggering of the actuator unit 18, which is coupled to the drive unit 16, of the machine tool 10, when the threshold value is exceeded for the purpose of displaying the presence identification situation.

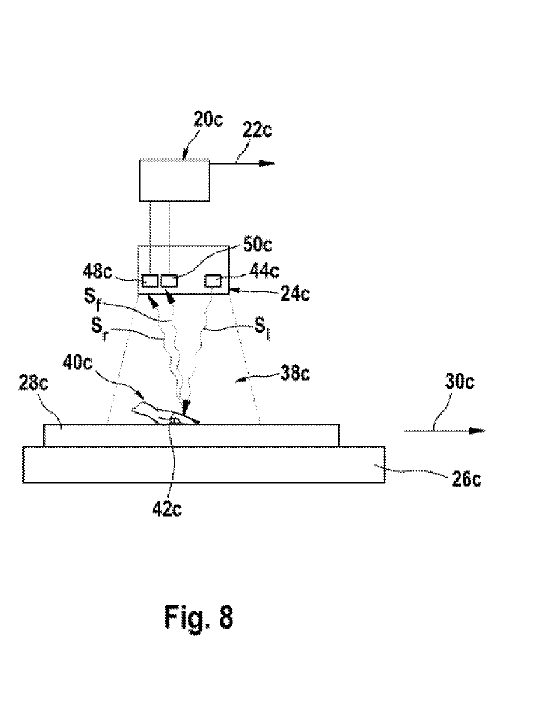

A further exemplary embodiment of a monitoring device is shown in FIG. 8. An identification device 24c comprises an emission unit 44c which is designed to be physically identical to the emission unit 44 according to the identification device 24 of FIG. 3 and likewise is provided for emitting electromagnetic radiation Sᵢ, which is amplitude-modulated at a modulation frequency f_{mod1} of 15 kHz, in the UV-A range, with an amplitude maximum at a wavelength λ of 375 nm. In contrast to the exemplary embodiment according to FIG. 3, the identification device 24c has two detector elements 48c, 50c, specifically a first detector element 48c with a sensitivity range for electromagnetic radiation in the UV range of between 200 nm and 380 nm and a second detector element 50c which has a sensitivity range for electromagnetic radiation which differs from the sensitivity range of the first detector element 48c and extends from the range of visible light (VIS) to the near infrared range (NIR).

A hand marking unit 40c which is formed by a glove exhibits, as the marking element 42c for marking a hand of an operator for presence identification, the fluorescence dye Rhodamine G in an outer surface of the glove, said dye having the fluorescence properties according to the exemplary embodiment of FIG. 6.

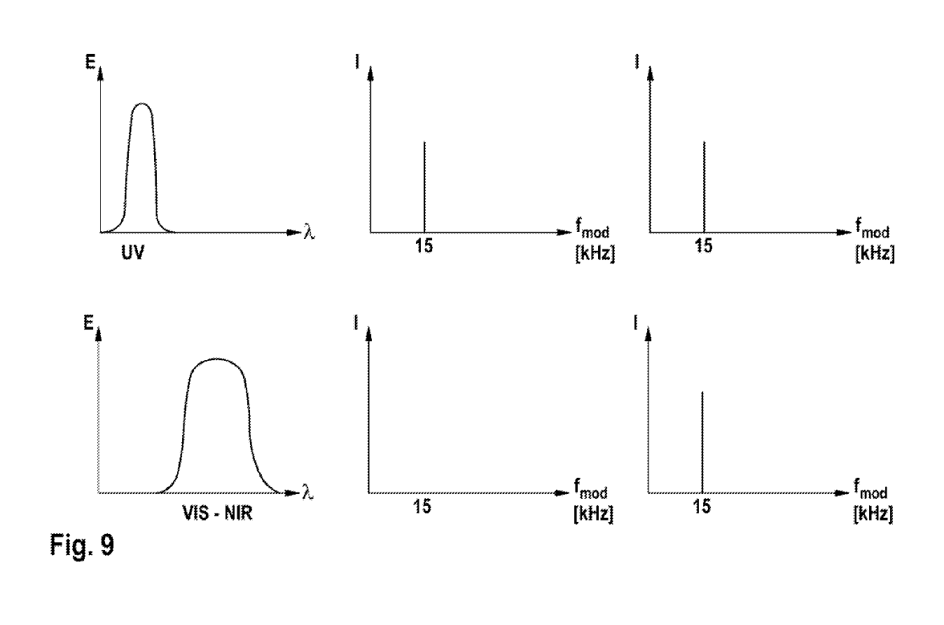

The left-hand part of FIG. 9 shows sensitivities E of the two detector elements 48c, 50c. The central part and the right-hand part of FIG. 9 show signal diagrams of the two detector elements 48c, 50c, which each qualitatively describe a situation in which the hand marking unit 40c which is formed by the glove is located outside (diagrams in the center) and inside (diagrams on the right-hand side) of the reaction area 38c.

The two diagrams in the center of FIG. 9 show signal amplitudes which are generated in the detector elements 48c, 50c and are filtered in a known manner with an electronic bandpass. When the glove is located outside the reaction area 38c, the first detector element 48c detects partially reflected radiation Sᵣ in the UV range. The second detector element 50c does not exhibit a signal at the modulation frequency f_{mod1} of the emission unit 44c. The two diagrams on the right-hand side qualitatively describe the situation when the glove is located in the reaction area 38c. The signal amplitude of the first detector element 48c is reduced by the electromagnetic radiation in the UV range which is absorbed by the fluorescence dye, while the signal amplitude of the second detector element 50c rises considerably due to electromagnetic radiation S_{f} in the range of visible light which is spontaneously emitted by the fluorescence dye.

The evaluation unit 20c is provided for identifying the presence of the hand marking unit 40c on the basis of a mathematical relationship between two radiation characteristic variables, specifically of intensities I, which are formed by the two amplitudes and are associated with different ranges of the electromagnetic spectrum, specifically the UV range and the VIS range. The evaluation unit 20c is also provided for comparing the mathematical relationship between the two radiation characteristic variables with threshold values which are stored in a memory element in an access area of the evaluation unit 20c, and for providing a signal 22c, which at least initiates triggering of the actuator unit 18, which is coupled to the drive unit 16, of the machine tool 10, when the threshold value is exceeded for the purpose of displaying the presence identification situation.

The two diagrams in FIG. 10 show, at the top, an absorption spectrum and, therebelow, an emission spectrum of the fluorescence dye Rhodamine 6G. Said figure also shows that electromagnetic radiation Sᵢ in the UV range, for example at the wavelength λ of 375 nm which is emitted by the emission unit 44, can be absorbed by the fluorescence dye Rhodamine 6G and, on account of its fluorescence property, electromagnetic radiation S_{f} can be spontaneously emitted in the range of visible light starting from a wavelength λ of approximately 500 nm (blue-green).

1. A monitoring device of a machine tool comprising:
an identification device configured to identify a presence of a type of material in a machine tool working area: and
at least one hand marking unit having at least one marking element specially adapted to be identified by the identification device to enable marking a hand of an operator.

2. The monitoring device of claim 1, characterized in wherein the at least one marking element and the identification device are specially matched to one another in respect of optical interaction.

3. The monitoring device of claim 1, wherein:
the identification device is configured to identify a presence of the at least one hand marking unit in the machine tool working area via spectral evaluation of electromagnetic radiation; amd
the identification device has at least one first detector element which is configured to detect the electromagnetic radiation to identify the presence of the at least one hand marking unit.

4. The monitoring device claim 3, wherein the at least one first detector element has a sensitivity range for electromagnetic radiation which extends from a UV range to a near infrared range.

5. The monitoring device as claimed in claim 3, wherein:
the identification device has an emission unit having at least one range of emission for electromagnetic radiation arranged at least partially in a UV range of an electromagnetic spectrum; and
the at least one hand marking unit is configured to interact in a targeted manner with the electromagnetic radiation of the UV range in at least one operating mode.

6. The monitoring device of claim 5, wherein the at least one hand marking unit has an albedo of more than 0.10 in at least one portion of the UV range of the electromagnetic spectrum.

7. The monitoring device of claim 5, wherein the at least one marking element has at least one photoluminescence property.

8. The monitoring device of claim 5, wherein the unit is configured to emit amplitude-modulated electromagnetic radiation.

9. The monitoring device of claim 5, further comprising a second detector element which has a sensitivity range for electromagnetic radiation which is different from the sensitivity range of the first detector element.

10. The monitoring device of claim 5, wherein the at least one hand marking unit is in the form of a glove, an outer surface of said glove having a photoluminescent dye.

11. The monitoring device of claim 9, the identification device further comprising an evaluation unit configured to identify the presence of the at least one hand marking unit via a mathematical relationship between at least two radiation characteristic variables which are associated with different ranges of the electromagnetic spectrum.

12. The monitoring device of claim 11, wherein the evaluation unit configured to provide a signal, as a result of identifying the presence of the at least one hand marking unit, which at least initiates triggering a protection system of the machine tool.
